(19) United States
(12) Patent Application Publication
(10) Pub. No.: US 2026/0320772 A1
(43) Pub. Date: Oct. 15, 2026

(54) SYSTEM FOR DETERMINING WEAR OF A COMPONENT OF A VEHICLE

(71) Applicant: NISSAN NORTH AMERICA, INC., Franklin, TN (US)

(72) Inventors: Vikram KRISHNAMURTHY, Marietta, GA (US); Shuyun TANG, Sunnyvale, CA (US); Robert BOLDIN, Gainesville, GA (US); Tengfei GONG, Milpitas, CA (US)

(21) Appl. No.: 19/179,365

(22) Filed: Apr. 15, 2025

(51) Int. Cl. G06T 7/00; G01M 17/007; G05B 23/02

(52) U.S. Cl. CPC G06T 7/001; G01M 17/007; G05B 23/0283; G06T 2207/20081

(57) ABSTRACT

A system for determining wear of a component of a vehicle, the system includes a sensor, a storage device, a receiver and a controller. The sensor determines a wear profile of the component. The storage device stores data related to the wear profile of the component. The receiver receives vehicle information from the vehicle, the vehicle information related to the wear profile of the component. The controller determines a status of the component based on a comparison of the wear profile of the component and the data related to the wear profile of the component and based on the vehicle information related to the to the wear profile of the component.

### BACKGROUND

### Technical Field

The present disclosure generally relates to a system for determining wear of a component of a vehicle. More specifically, the present disclosure relates to a system for determining the status of a component based on a comparison of a wear profile of the component and data related to the wear profile of the component.

### Background Information

Conventional systems can estimate tire tread depth using optical information of a tire surface. These systems can use a light source to emit light onto a surface of a vehicle tire. A camera captures an image of the surface of the vehicle tire, and an electronic controller estimates a depth of a tire tread of the vehicle tire based on the image received from the camera.

### SUMMARY

It has been determined that an improvement in determining wear of a component of a vehicle is desired. That is, the conventional system estimate the tire tread depth, but provide little additional information. The present disclosure relates to determining the status of a component of a vehicle and whether the component needs to be replaced, an estimate for component life and modifications to the vehicle components to improve component life.

In view of the state of the known technology, one aspect of the present disclosure is to provide a system for determining wear of a component of a vehicle, the system comprising a sensor, a storage device, a receiver and a controller. The sensor is configured to determine a wear profile of the component. The storage device is configured to store data related to the wear profile of the component. The receiver is configured to receive vehicle information from the vehicle, the vehicle information related to the wear profile of the component. The controller is configured to determine a status of the component based on a comparison of the wear profile of the component and the data related to the wear profile of the component and based on the vehicle information related to the to the wear profile of the component.

Another aspect of the present disclosure is to provide a method for determining wear of a component of a vehicle, the method comprising determining, using a sensor, a wear profile of the component, retrieving data related to the wear profile of the component from a storage device, receiving, via a receiver, vehicle information from the vehicle, the vehicle information related to the wear profile of the component, and determining, via a controller, a status of the component based on a comparison of the wear profile of the component and the data related to the wear profile of the component and based on the vehicle information related to the to the wear profile of the component

By providing a device and method as disclosed herein, accurate predictions of wear and use of a component can be achieved. That is, the system as disclosed herein can predict the useable lifespan remaining on a component and provide an accurate evaluation of when the component will be required to be replaced. Moreover, the system is capable of diagnosing potential errors in the operation and configuration of the component or related components and provide real time recommendations for improving use and operation of the components and the related components.

### BRIEF DESCRIPTION OF THE DRAWINGS

Referring now to the attached drawings which form a part of this original disclosure:

FIG. 1 is a schematic view of a system for determining wear of a component of a vehicle according to an embodiment;

FIG. 2 illustrates a vehicle including a control system that can operate with the system for determining wear of a component of a vehicle according to the embodiment of FIG. 1;

FIG. 3 illustrates the system for determining wear of a component of a vehicle according to the embodiment of FIG. 1 capturing an image of a tire and any wear of the tire treads;

FIGS. 4A-4F illustrate types of tire wear;

FIG. 5 illustrates a braking system with a brake pad;

FIG. 6 illustrates wear of a brake pad;

FIG. 7 is a flow chart illustrating the method of predicting component interval or life span according to one embodiment;

FIG. 8 is a flow chart illustrating the method of predicting component interval or life span according to another embodiment;

FIG. 9 is a flow chart illustrating a method of diagnosing a component issue;

FIG. 10A and FIG. 10B and illustrate a diagnosed problem of negative camber for a tire;

FIG. 11A and FIG. 11B illustrate graphs indicating the width and location of a wear spot on a tire and the camber angle related thereto for a tire having negative camber;

FIG. 12A and FIG. 12B illustrate a diagnosed problem of positive camber for a tire;

FIG. 13A and FIG. 13B illustrate graphs indicating the width and location of a wear spot on a tire and the camber angle related thereto for a tire having positive camber;

FIGS. 14A-14C illustrate an overinflated tire and the width and location of a wear spot on an overinflated tire; and

FIGS. 15A-15C illustrate an underinflated tire and the width and location of a wear spot on an underinflated tire.

It should be noted that these figures are intended to illustrate the general characteristics of methods, structure and/or materials utilized in certain illustrative embodiments and to supplement the written description provided below. These drawings are not to scale and may not precisely reflect the precise structural or performance characteristics of any given embodiment and should not be interpreted as defining or limiting the range of values or properties encompassed by illustrative embodiments unless specified.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the disclosure as defined by the appended claims and their equivalents.

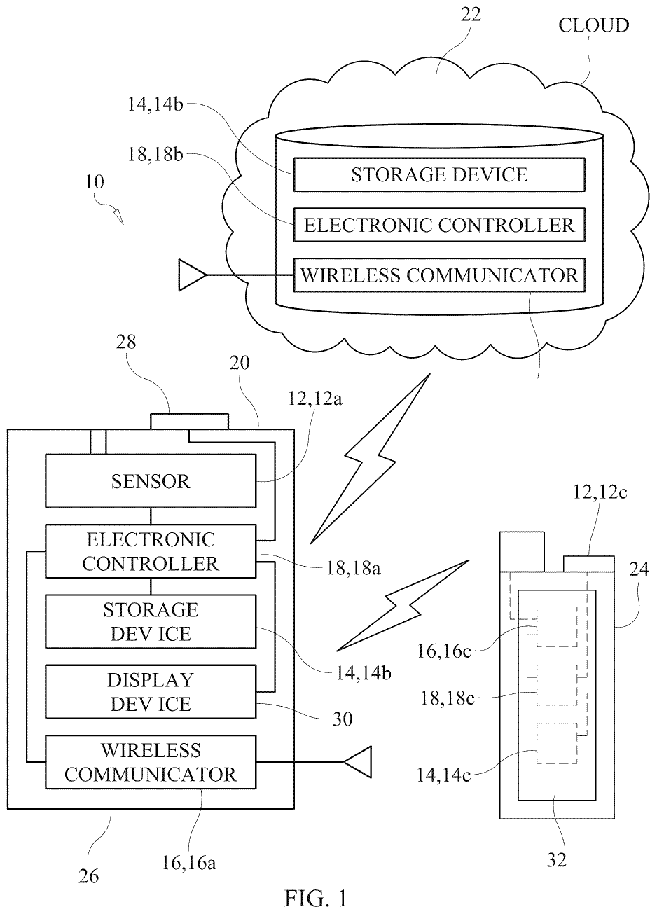

Referring initially to FIG. 1, a system for determining wear 10 of a component of a vehicle is illustrated in accordance with a first embodiment. The system for determining wear 10 of a component of a vehicle can include a sensor 12, a storage device 14, a wireless communicator 16 (including a receiver), and a controller 18.

As discussed in detail below, the system can be disposed in any one of or a combination of a device 20, a remote server 22 in the cloud and a peripheral device 24. These elements can operate in conjunction with ne another in any capacity to improve efficiency of the system and to reduce the storage space required within any one component.

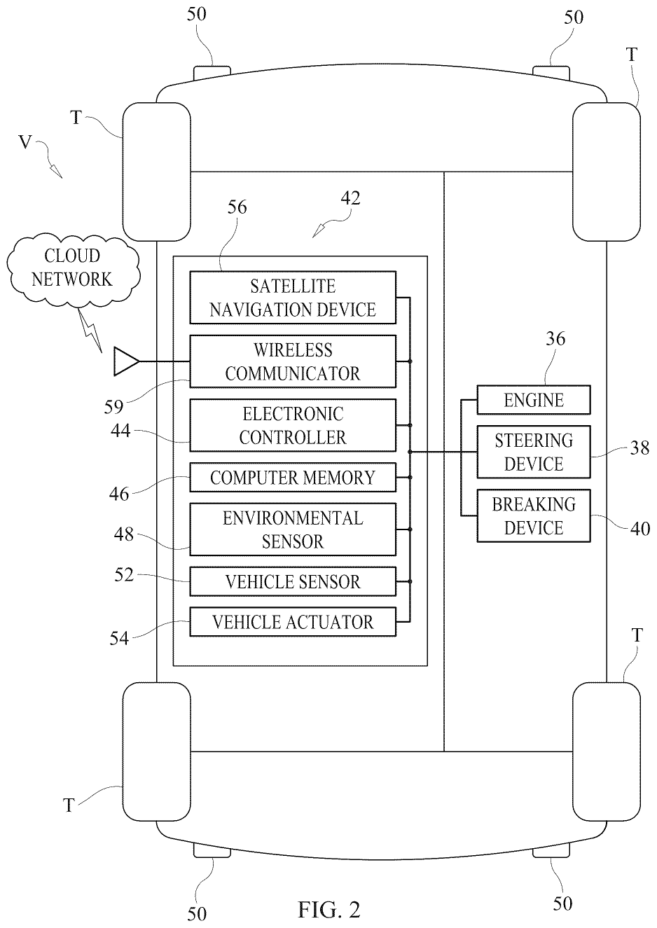

The device 20 in the system for determining wear 10 of a component of a vehicle can be an inspection device 20 configured to obtain dimensional or wear information from the vehicle component C (see FIG. 3), as shown in FIG. 1. In this embodiment, the device 20 includes a housing 26 for the various components described herein. Accordingly, the sensor 12 for the system for determining wear 10 of a component can be sensor 12A, such as a camera configured to capture the image of an outer surface of a tire or the outer surface of a brake pad or other component (such as a filter). In one embodiment, the device 20 can include a conventional wireless borescope or endoscope having a light source 28 and the camera (sensor 12, 12), as shown in FIGS. 1 and 3. The system for determining wear 10 of a component includes the device 20 or structure in which the light source 28 and the camera are disposed. The device 20 can include a flexible tube, as shown in FIG. 3. It is noted that while the sensor 12A can be a camera, the sensor 12A can be any suitable sensor configured to capture an image of a vehicle component C, or to capture a wear profile of a component of the vehicle V.

Furthermore, the device 20 is a structural component that can located with or adjacent the vehicle V. In other words, the device 20 is a positional device that is configured to capture images of a component of a vehicle V in real time.

In the illustrated embodiment, the device 20 can include the electronic control unit or controller 18A (e.g., a processor) and the storage device 14A. The electronic controller 18A includes one or more processor(s) for controlling the various operations of the device 20, as will be further described. In the illustrated embodiment, the electronic controller 18A is preferably a microcomputer (MPU) or central processing unit (CPU). The electronic controller 18A is formed of one or more semiconductor chips that are mounted on a circuit board. The term “electronic control unit” or “electronic controller” as used herein refers to hardware that executes a software program, and does not include a human being. The MPU or CPU can be one or more integrated circuits having firmware for causing the circuitry to complete the activities described herein. Of course, any number of other analog and/or digital components capable of performing the functionality described below can be provided in place of, or in conjunction with the electronic controller 18A.

The storage device 14A is any memory or computer memory. Here, for example, the storage device 14A includes a transitory or non-transitory computer-readable medium with the sole exception of a transitory propagating signal. Thus, the storage device 14A can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The storage device 14 stores various control processes or control programs as well as information or data used by the electronic controller 18A. Thus, the storage device 14A is electrically connected to the electronic controller 18A. In this way, the electronic controller 18A can retrieve data and access programs stored in the storage device 14A, and can store data to the storage device 14A. As explained below, the storage device 14A preferably includes non-volatile memory that is configured to store various control programs (e.g., a program for a vehicle V control method, etc.), operational data, component identification data, etc.

In the illustrated embodiment, the storage device 14A is configured to store at least one reference image associated with a wear profile of a tire T or the wear profile of a brake pad BP. More particularly, the storage device 14A is configured to store a plurality of reference images associated with the wear profile of a tire T or the wear profile of a brake pad PD. For example, the storage device 14A can store images of tires T and brake pads PD of varying wear profiles that can be used as reference for comparison to the detected values obtained by the device 20. Therefore, the storage device 14A includes pre-stored reference wear profiles that can be used to determine the wear profile of the tire T or the wear profile of the brake pad PD. The storage device 14A can store an image library having a plurality of reference tire images for comparing to the captured image of the tire T or the brake pad PD.

The storage device 14A can also store non-transitory computer readable media (e.g., audio, image and video files), computer program instructions or software, preference information, device profile information, and any other suitable data. The storage preferably further contains convolutional neural networks (CNN) or other types of image recognition/processing software. The memory and/or the storage can be used to retain computer program instructions or code organized into one or more modules and written in any desired computer programming language. The processor of the electronic controller 18A can execute such computer program code by implementing one or more of the methods described herein.

As shown in FIG. 1, the device 20 further includes an electronic display or display device 30 that can display information regarding the reference images that are stored in the storage device 14A, and/or live images captured by the inspection device 20. The display device 30 can further display other information accessible by electronic controller 18 A. The display device 30 is preferably a touchscreen that is an assembly of both an input (‘touch panel’) and output (‘display’) device. The touch panel is normally layered on the top of an electronic visual display of an information processing system. The display device 30 can be a liquid-crystal display (LCD), active-matrix organic light-emitting diode (AMOLED) display, an organic light-emitting (OLED) display, or any other suitable display.

The wireless communicator 16 can be wireless communicator 16A in wireless communications with at least one of cloud services (e.g., remote server 22). The wireless communicator 16A can be a hardware device capable of transmitting and/or receiving an analog or digital signal wirelessly via an antenna. The terms “wireless communicator” as used herein include a receiver, a transmitter, a transceiver, or a transmitter-receiver, for example. The wireless communicator 16A is capable of transmitting and/or receiving wireless communication signals, including control, command or other signals related to a function of the component being controlled. The wireless communication signals can be radio frequency (RF) signals, ultra-wide band communication signals, or Bluetooth communications or any other type of signal suitable for wireless communications as understood in the field. Here, the wireless communication communicator 16A can be a two-way wireless communication unit having a receiver and a transmitter.

In the illustrated embodiment, the electronic controller 18A and the storage device 14A can be provided within the housing 26 of the device 20. The electronic controller 18A and the storage device 14A for the system for determining wear 10 of a component of a vehicle can alternatively be provided as part of the external server or a remote server. For example, the processing and computing operations described for the electronic controller 18A and storing functions of the storage device 14A herein can alternatively be performed on a cloud. That is, the programs and applications for determining the wear profile of the component C can be stored on the cloud, which the other components of system for determining wear 10 of a component of a vehicle can be connected to.

The electronic controller 18 can therefore be a central processing unit or electronic controller 18B of the cloud so that the wear profile determination is performed on the cloud. Accordingly, in some embodiments, the aspects of the remote server can be considered part of the system 10.

As illustrated in FIG. 1, the remote server 22 includes an electronic controller 18B, a storage device 14B and a wireless communicator 16B. The electronic controller 18B includes one or more processor(s) for controlling the various operations of the device, as will be further described. In the illustrated embodiment, the electronic controller 18 is preferably a microcomputer (MPU) or central processing unit (CPU). The electronic controller 18B is formed of one or more semiconductor chips that are mounted on a circuit board. The term “electronic control unit” or “electronic controller” as used herein refers to hardware that executes a software program, and does not include a human being. The MPU or CPU may be one or more integrated circuits having firmware for causing the circuitry to complete the activities described herein. Of course, any number of other analog and/or digital components capable of performing the functionality described below can be provided in place of, or in conjunction with the electronic controller 18B.

The storage device 14B is any memory or computer memory. Here, for example, the storage device 14B includes a transitory or non-transitory computer-readable medium with the sole exception of a transitory propagating signal. Thus, the storage device 14B can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The storage device 14B stores various control processes or control programs as well as information or data used by the electronic controller 18B. Thus, the storage device 14B is electrically connected to the electronic controller 18B. In this way, the electronic controller 18B can retrieve data and access programs stored in the storage device 14B, and can store data to the storage device 14B. As explained below, the storage device 14B preferably includes non-volatile memory that is configured to store various control programs (e.g., a program for a vehicle V control method, etc.), operational data, component identification data, etc.

In the illustrated embodiment, the storage device 14B is configured to store at least one reference image associated with a wear profile of a tire T or the wear profile of a brake pad PD. More particularly, the storage device 14B is configured to store a plurality of reference images associated with the wear profile of a tire T or the wear profile of a brake pad PD. For example, the storage device 14B can store images of tires T and brake pads PD of varying wear profiles that can be used as reference for comparison to the detected values obtained by the system 10. Therefore, the storage device 14B includes pre-stored reference wear profiles that can be used to determine the wear profile of the tire T or the wear profile of the brake pad PD. The storage device 14B can store an image library having a plurality of reference tire or brake pad images for comparing to the captured image of the tire T or the brake pad PD.

The storage device 14B can also store non-transitory computer readable media (e.g., audio, image and video files), computer program instructions or software, preference information, device profile information, and any other suitable data. The storage preferably further contains convolutional neural networks (CNN) or other types of image recognition/processing software. The memory and/or the storage can be used to retain computer program instructions or code organized into one or more modules and written in any desired computer programming language. The processor of the electronic controller 18B can execute such computer program code by implementing one or more of the methods described herein.

The wireless communicator 16B can be a hardware device capable of transmitting and/or receiving an analog or digital signal wirelessly via an antenna. The terms “wireless communicator” as used herein include a receiver, a transmitter, a transceiver, or a transmitter-receiver, for example. The wireless communicator 16B is capable of transmitting and/or receiving wireless communication signals, including control, command or other signals related to a function of the component being controlled. The wireless communication signals can be radio frequency (RF) signals, ultra-wide band communication signals, or Bluetooth communications or any other type of signal suitable for wireless communications as understood in the field. Here, the wireless communication communicator 16B can be a two-way wireless communication unit having a receiver and a transmitter.

In this embodiment, the controller 18A in the device 20 can be in communication with the server 22 through the wireless communicators 16A and 16B. Thus, as described herein, the sensor 12A can acquire an image which is then uploaded to the remote server 22. The electronic controller 1B8 in the cloud can then make the determinations and predictions described herein, and the information can then be transmitted through the wireless communicator 16B back to the device 20.

In one embodiment, the system for determining wear 10 of a component can work in conjunction with the peripheral device 24, such that some components are disposed within the device 20 and some components are disposed within the peripheral device 24. For example, the peripheral device 24 can be a phone, tablet or computer with a controller 18 (e.g., controller 18C), a storage device 16C, a sensor 12C and a wireless communicator 16C disposed therein. The device 20 can be in communication with the peripheral device 24, such that an image taken by the device 20 is uploaded to the peripheral device 24 through the wireless communicators 16A and 16C, which in turn uploads the image to the cloud and/or remote server 22 through another wireless communicator 16B. In this embodiment, the peripheral device 24 can communicate with both the remote server 22 and the device 20.

In one embodiment, the electronic controller 18 and the storage device 14 can alternatively be provided as part of the peripheral device 24. For example, the processing and computing operations described for the electronic controller 18C and storing functions of the storage device 14C herein can alternatively be performed on the peripheral device 24. That is, the programs and applications for determining the wear profile of the component C can be stored on the peripheral device 24, which the device 20 can be connected to. The electronic controller 18C can therefore be a central processing unit of the peripheral device 24 so that the wear profile determination is performed on the peripheral device 24. It will be apparent to those skilled in the vehicle V field from this disclosure that the electronic controller 18 can be disposed in any suitable location. Accordingly, as can be understood, in some embodiments, the peripheral device 24 can be considered part of the system for determining wear 10 of a component.

The device 20 and/or the peripheral device 24 can include at least one software application that is installed to detect, measure, store and/or send information regarding the wear profile of the component C. Therefore, the electronic controller 18C is in electronic communication with the device 20 to receive the image of the surface of the tire T. That is, the inspection device 20 can upload image data to the peripheral device 24 to be processed by the electronic controller 18C in the peripheral device 24. The electronic controller 18C is programmed to determine the tire wear profile of the component based on the image captured by the inspection device 20.

In the illustrated embodiment, the storage device 14C is configured to store at least one reference image associated with the wear profile of a tire T or the wear profile of a brake pad PD. More particularly, the storage device 14C is configured to store a plurality of reference images associated with the wear profile of a tire T or the wear profile of a brake pad PD. For example, the storage device 14C can store images of tires T of varying wear profiles or wear profiles of a brake pad PD that can be used as reference for comparison to the detected values obtained by the device 20. Therefore, the peripheral device 24 includes pre-stored reference wear profiles that can be used to determine the wear profile of a tire T or the wear profile of a brake pad PD. The storage device 14C can store an image library having a plurality of reference profile images for comparing to the captured image.

The storage device 14C can also store non-transitory computer readable media (e.g., audio, image and video files), computer program instructions or software, preference information, device profile information, and any other suitable data. The storage preferably further contains convolutional neural networks (CNN) or other types of image recognition/processing software. The memory and/or the storage can be used to retain computer program instructions or code organized into one or more modules and written in any desired computer programming language. The processor of the electronic controller 18 can execute such computer program code by implementing one or more of the methods described herein.

As shown in FIG. 1, the peripheral device 24 further includes an electronic display 32 that can display information regarding the reference images that are prestored in the storage device 14C, and/or live images captured by the inspection device 20. The electronic display 32 can further display other information accessible by the processor of the electronic controller 18C. The electronic display 18C is preferably a touchscreen that is an assembly of both an input (‘touch panel’) and output (‘display’) device. The touch panel is normally layered on the top of an electronic visual display of an information processing system. The electronic display 32 can be a liquid-crystal display (LCD), active-matrix organic light-emitting diode (AMOLED) display, an organic light-emitting (OLED) display, or any other suitable display.

The user can provide input or control the information processing system through multi-touch gestures by touching the display screen with a special stylus or one or more fingers. The user can use the touchscreen to react to what is displayed and, if the software allows, to control how it is displayed; for example, zooming to increase the text size. As stated, the electronic controller 18C is programmed to control the electronic display 32 to display an indication wear profile and, life span prediction, diagnostic information or any other suitable information as discussed herein. The indication can include text such as “the tire needs replacement” or “the tire will need replacement soon.”

The processor of the electronic controller 18C can be any suitable programmable control device capable of executing instructions necessary to carry out or control the operation of the many functions performed by the peripheral device 24 (e.g., such as the processing of images captured by the inspection device 20 and/or infrared imaging or ultrasound). The electronic controller 18C can, for instance, control the electronic display 32 and receive user input from user interface which can take a variety of forms, such as a button, keypad, dial, a click wheel, keyboard, display screen and/or a touch screen. The electronic controller 18C can be a system-on-chip and include a dedicated graphics processing unit (GPU).

The electronic controller 18C can be based on reduced instruction-set computer (RISC) or complex instruction-set computer (CISC) architectures or any other suitable architecture and may include one or more processing cores. The peripheral device 24 is preferably further equipped with graphics hardware, such as special purpose computational hardware for processing graphics, and/or an assisting processor to process graphics information. The graphics hardware can include one or more programmable graphics processing units (GPUs).

The peripheral device 24 can be in communication with the cloud or the remote server 22 through the wireless communicators 16B and 16C, such that the peripheral device 24 can upload and/or download information to and from the cloud. Moreover, the peripheral device 24 can be in communication with the device 20 and can send and receive data to the device 20.

As also seen in FIG. 2, the vehicle V is equipped with a vehicle engine 36 and other conventional vehicle components, such as a steering device 38, a braking device 40, etc. These components can be considered part of the vehicle control system 22. As can be understood, any component of the vehicle V that enables operation of the vehicle V and/or control of the vehicle V can be considered an element of the vehicle control system 42. The vehicle engine 24 generates a torque output of the vehicle V in accordance with the operation of the vehicle pedal by the driver. The torque output generated by the vehicle engine 24 is then transferred to the wheels of the vehicle V through the transmission and the drivetrain of the vehicle V in a conventional manner. The vehicle engine 24 can be further equipped with an electronic control unit (ECM). In particular, the ECM controls a torque output of the vehicle engine 24. In the illustrated embodiment, the vehicle engine 24 includes an electric engine. Alternatively, the vehicle V can be a hybrid or a combustion vehicle, or be operated by a hydrogen powertrain.

In the illustrated embodiment, the vehicle control system 42 includes the electronic control unit or controller 44 (e.g., a processor) and the computer memory 46. The electronic controller 44 includes one or more processor(s) for controlling the various operations of the vehicle V, as will be further described. In the illustrated embodiment, the electronic controller 44 is preferably a microcomputer (MPU) or central processing unit (CPU). The electronic controller 44 is formed of one or more semiconductor chips that are mounted on a circuit board. The term “electronic control unit” or “electronic controller” as used herein refers to hardware that executes a software program, and does not include a human being. The MPU or CPU may be one or more integrated circuits having firmware for causing the circuitry to complete the activities described herein. Of course, any number of other analog and/or digital components capable of performing the functionality described below can be provided in place of, or in conjunction with the electronic controller 44.

The computer memory 46 is any memory or computer memory. Here, for example, the computer memory 46 includes a transitory or non-transitory computer-readable medium with the sole exception of a transitory propagating signal. Thus, the computer memory 46 can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The computer memory 46 stores various control processes or control programs as well as information or data used by the electronic controller 44. Thus, the computer memory 46 is electrically connected to the electronic controller 44. In this way, the electronic controller 44 can retrieve data and access programs stored in the computer memory 46, and can store data to the computer memory 46. As explained below, the computer memory 46 preferably includes non-volatile memory that is configured to store various control programs (e.g., a program for a vehicle control method, etc.), operational data, component identification data, etc.

In the illustrated embodiment, the vehicle control system 42 can further include the environmental sensor 48. The environmental sensor 48 detects the traveling environment of the vehicle V, as will be further discussed below. For example, the environmental sensor 48 can be equipped with one or more unidirectional or omnidirectional external cameras 50 that take moving or still images of the traveling environment or surroundings of the vehicle V. The environmental sensor 48 can also include infrared detectors, ultra-sonic detectors, radar detectors, photoelectric detectors, magnetic detectors, acceleration detectors, acoustic/sonic detectors, gyroscopes, lasers or any combination thereof. The environmental sensor 48 can also include object-locating sensing devices including range detectors, such as FM-CW (Frequency Modulated Continuous Wave) radars, pulse and FSK (Frequency Shift Keying) radars, sonar and Lidar (Light Detection and Ranging) devices. The data from the environmental sensor 48 can be used to detect the environment of the vehicle V, as will be further described below. In any case, in the illustrated embodiment, the environmental sensor 48 includes at least one of a lidar sensor (Lidar), a radar sensor (radar) and an image sensor (camera). Moreover, the environmental sensor 48 can detect any suitable environment condition exterior to the vehicle, such as the weather data, i.e., precipitation, temperature, air salt content and any other desired variable.

The vehicle control system 42 can also include a vehicle sensor 52 to detect driving states of the vehicle V. For example, the vehicle sensor 52 includes a vehicle speed sensor, a yaw rate sensor, a torque sensor, etc. The vehicle speed sensor can measure wheel speed of the vehicle V in a conventional manner to detect current vehicle speed of the vehicle. The yaw rate sensor detects the yaw rate generated in the vehicle V in a conventional manner. The torque sensor can measure the torque on the crankshaft of the vehicle engine 24 in a conventional manner.

Both the environmental sensor 48 and the vehicle sensor 52 can record and store this information in the computer memory 46. Moreover, this information can be stored in a historical manner to determine the length of time of the sensed condition and the time and date of the sensed condition.

In the illustrated embodiment, the vehicle control system 42 further includes a vehicle actuator 54, a satellite navigation device 56 and a wireless communicator 58. The vehicle actuator 54 is operatively connected to the electronic controller 44 to operate the vehicle components of the vehicle V according to the autonomous driving control and/or the driving assist control. Specifically, the vehicle actuator 54 includes a steering actuator, a brake control actuator, etc. The steering actuator operates the steering device of the vehicle V to control the steering angle of the vehicle V. The brake control actuator operates the braking device to control the deceleration of the vehicle V. In the illustrated embodiment, the electronic controller 44 can be in communication with the ECM of the vehicle engine 24 to operate the vehicle engine 24 to control the acceleration of the vehicle V. However, the vehicle actuator 54 can further include an accelerator opening actuator that operates the throttle of the vehicle engine 24 to control the acceleration of the vehicle V.

The satellite navigation device 56 includes a global navigation satellite system (GNSS) receiver. In the illustrated embodiment, the GNSS receiver can be a global positioning system (GPS) receiver, for example. The satellite navigation device 56 receives radio waves from a plurality of navigation satellites to obtain information that represents, for example, a current vehicle heading of the vehicle, a current vehicle position of the vehicle in two or three dimensions, a current vehicle angular orientation of the vehicle, or a combination thereof.

The wireless communicator 58 is in wireless communications to at least one of cloud or remote server 22, the device 20 and the peripheral device 24 and/or a vehicle network. The wireless communicator 58 is a hardware device capable of transmitting and/or receiving an analog or digital signal wirelessly via an antenna. The terms “wireless communicator” as used herein include a receiver, a transmitter, a transceiver, or a transmitter-receiver, for example.

The wireless communicator 58 enables the vehicle control system to upload information to the system 10, the cloud and/or the server 22. For example, the vehicle control system 42 can upload vehicle information including vehicle miles, time, vehicle speed, vehicle acceleration, vehicle g forces, vehicle trajectory and/or the weather at the location of the vehicle V. In other words, the vehicle control system 42 can detect various parameters of the vehicle V, both internal and external, that can have an affect on the driving characteristics and the driving parameters and upload this information to the remote server 22 or to any of the device 20 and the peripheral device 24. The vehicle control system 42 can detect and determine any suitable driving parameter or environmental parameter that may have an affect on the wear profile of the component C, and upload such information to the cloud and/or remote server 22 or to any of the device 20 and the peripheral device 24.

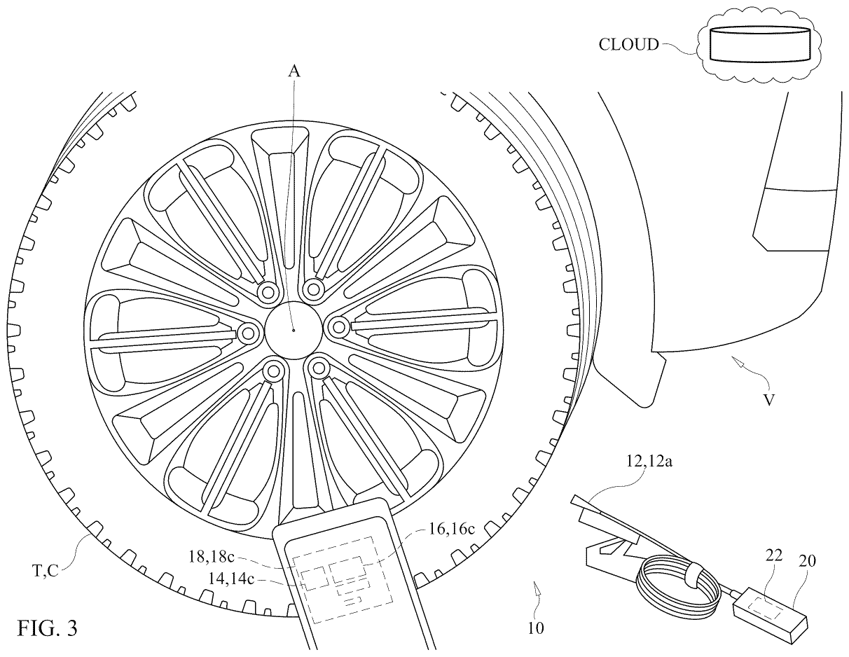

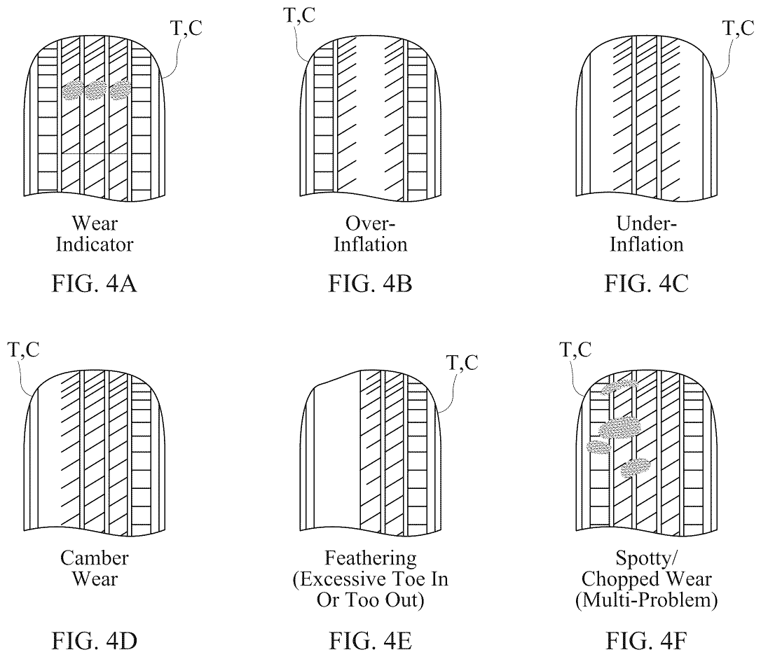

In one embodiment, the system 10 is configured to determine a wear profile of a tire T. FIGS. 4A-4F illustrates exemplary wear profiles that can be determined by the device. FIG. 4A illustrates an example of a tire T that was worn to a wear indicator. As can be understood, wear indicators are marks spaced evenly along the tire T tread. Based on the wear indicators, a determination of the how much of the tire T tread depth has worn down can be made.

FIG. 4B illustrates the wear profile of a tire T that has been over inflated. In this example, the tire T can wear generally in the central portion of the tread area. FIG. 4C illustrates the wear profile of a tire T that has been over underinflated. In this example, the tire T can wear generally in the peripheral portions of the tread area. FIG. 4D illustrates a tire T that has chamber wear. In this example, the tire T can wear generally in one side of a peripheral portion of the tread area. FIG. 4E illustrates a tire T that has feathering wear. In this example, the tire T can wear generally in one side of a peripheral portion of the tread area, but with a different profile than a tire T that has chamber wear. FIG. 4F illustrates a tire T that has spotty or chopped wear. In this example, the tire T can wear in various, inconsistent portions of the tread area.

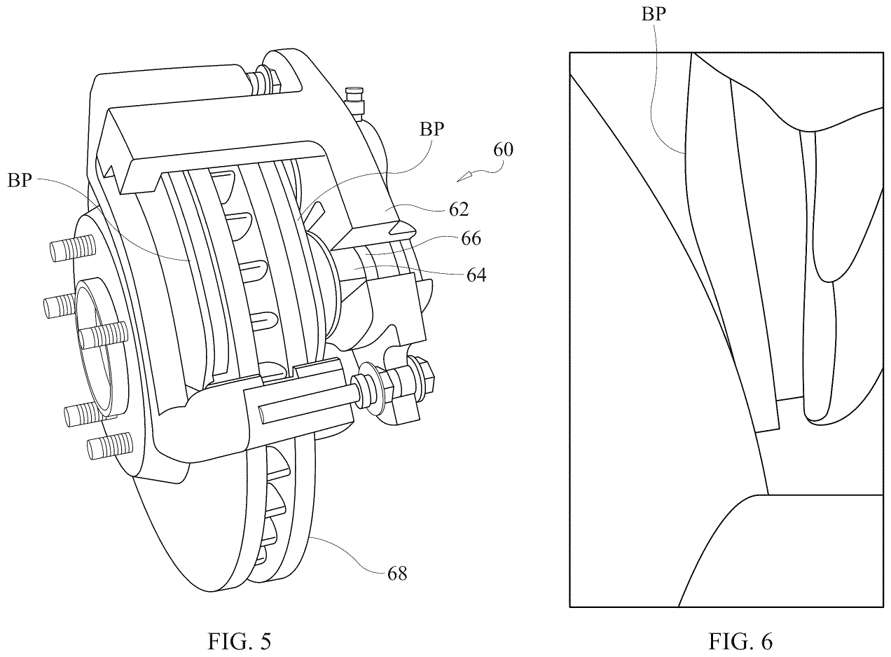

FIG. 5 illustrates a disc brake caliper assembly 60. As can be understood, the disc brake caliper assembly can include a caliper 62, a piston 64, a dust boot 66, a rotor 68 and brake pards BP. The system 10 can take an image of the brake pad BP to determine the wear profile of the brake pad, as shown in FIG. 6.

As can be understood, to be capable of providing accurate and consistent predictions of the life span of the component and an accurate diagnosis of any abnormal wear, the controller 18 (controllers 18A, 18B, and/or 18C) can be programed with a convoluted neural network with a deep learning algorithm that involves image and video analysis, such as image classification, object detection, and segmentation. The convoluted neural network can be designed to automatically and adaptively learn spatial hierarchies of features from input images of the component C (tires T and/or brake pad BP) of the vehicle V.

The storage device 14 (storage devices 14A, 14B and/or 14C) can have a plurality of wear profiles stored therein. That is, the profile for a plurality of new tires or brake pads can be uploaded into the storage device 14. These initial new component profiles can be associated with “new” component metadata, indicating that each of these components is in a new or unused condition. To train the convoluted neural network a plurality of images of the components can be uploaded to be compared to the “new” component profile. Each of these images can have metadata associated with the image. For example, as discussed herein, the metadata can include vehicle information including vehicle miles, time, date, vehicle speed, vehicle acceleration, vehicle g forces, vehicle trajectory and/or the weather at the location of the vehicle V, the alignment of the component, the position of the camber, the condition of the calipers 62, the condition of the rotors 68, or any other suitable information of the vehicle V. These metadata files can be in formats like JSON, TXT, or YAML that provide essential details about each image.

Based on the plurality of images and the associated metadata, the convoluted neural network is trained to identify the wear profile of the component and actual determined life span of a component. Thus, given an image of a wear profile taken by the sensor 12, the system is capable of determining, the current state of the component, including rate of wear of the component, predicted lifespan of the component and any adjustments to the component to increase the lifespan of the component.

A plurality of wear profiles can be uploaded from various places and locations to the remote server 22 in the cloud or any of the suitable storage device 16A, 16B and/or 16C. Such uploads can occur at any interval desired and thus, the convoluted neural network will continue to increase the accuracy of the rate of wear of the component, predicted lifespan of the component and any adjustments to the component to increase the lifespan of the component as additional images are stored in the storage device 14.

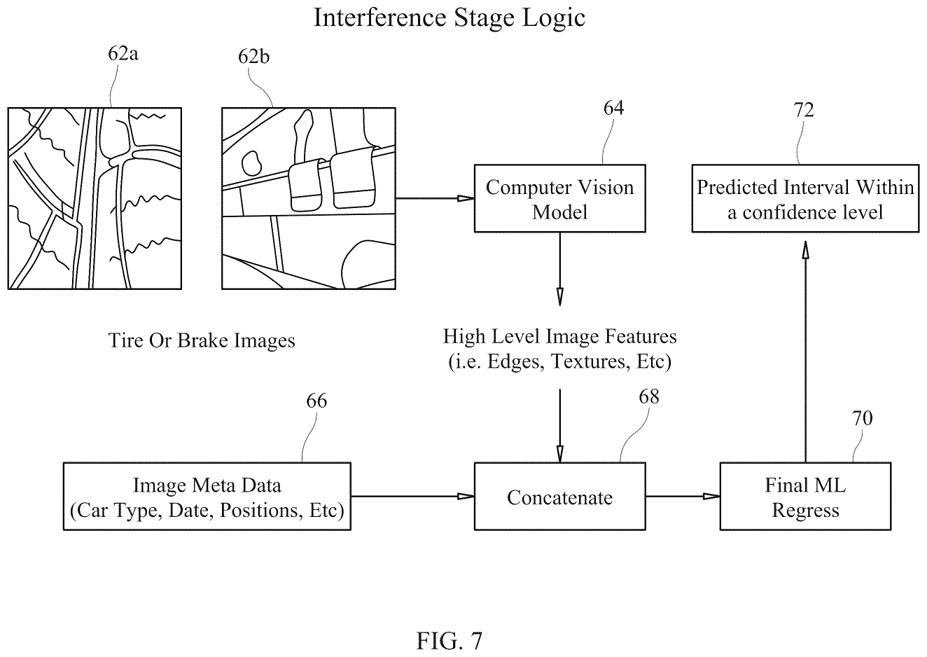

FIG. 7 illustrates one embodiment of a process that provides an accurate prediction of the component lifespan (e.g., the tire or the brake pad or other component such as a filter) with a high degree of confidence. In this embodiment, the tire or brake images 62a and 62b can be uploaded to a computer vision models 64. The computer vision models can be convoluted neural networks stored in the storage device 18. Preferably, the images include high level image features, such edges, textures, etc. Moreover, the image meta data 66 simultaneously, substantially simultaneously or at any other suitable time can be uploaded to the storage device 14. For example, at the time that the sensor 12 obtains an image of the component C, the vehicle V can also transmit data that may be relevant to the wear profile of the component. For example, as discussed herein, the vehicle control system can upload vehicle information including vehicle miles, time, vehicle speed, vehicle acceleration, vehicle g forces, vehicle trajectory and/or the weather at the location of the vehicle V, the alignment of the component, the position of the camber, the condition of the calipers 62, the condition of the rotos, or any other suitable information of the vehicle V that can be associated with the wear profile. This information can be related to the wear of the tire and can contribute to a specific wear profile. The wireless communication device 16 (that includes a receiver) can receive vehicle information from the vehicle V, the vehicle information related to the wear profile of the component.

This information can be concatenated 68 with the images of the wear profile of the component. In other words, the system 10 can associate the metadata from the vehicle V with the image of the wear profile of the component of the vehicle V. The system 10 can perform a final machine learning regressor 70. That is, the system 10 can perform regression analysis in which the system is trained with a plurality of input images of the component and the associated metadata. Based on a comparison of the wear profile of the component to the profile of the component when “new”, the system 10 is capable of accurately learning the predicted life span of the component C. That is, controller 18 determines a status of the component C based on a comparison of the wear profile of the component C and the data related to the wear profile of the component stored in the storage device 14 and based on the vehicle information related to the to the wear profile of the component (image meat data 66).

In one embodiment, the system for determining wear 10 of a component of a vehicle, can be trained as follows: 1) capturing a plurality of images related to a wear profile of the component C; 2) transmitting the plurality of images to a remote server; 3) transmitting information related to the vehicle V to the remote server; 4) concatenating the images of the wear profile of the component C to the information related to the vehicle V to provide concatenated information; and inputting the concatenated information into a machine learning model to provide an output predicting the remaining usable lifespan of the component C. It is further noted that while this embodiment discusses transmitting the images the to the remote server 22, here the “remote server” can be considered as the device 20, as the remote server 22 and/or as the peripheral device 24. These three elements can communicate with each other for maximum controller efficiency and utilization of storage space. Furthermore, any two of the devices can be considered the system for determining the replacement of a component of a vehicle V. For example, in one embodiment, the device 20 and/or the peripheral device 24 can include a camera and thus capture and store the information in the storage device 14A and/or 14C and be used to train the system or operate in conjunction with the remote server 22 and/or the device 20.

As can be understood, the system 10 has a plurality of images of a component stored in the storage device 14. These images are associated with, for example, the miles the vehicle V has driven, the environment in which the vehicle V has been driven and the other parameters which the vehicle V has been subjected to. Based on these parameters and the known wear profiles stored in the storage device 14, the system is capable of providing a predicted interval or lifespan which the component will have with a high confidence level. In other words, the system can estimate the lifespan left on the component and provide this information on the display device 30 and/or electronic display 32. The controller 18 is thus capable of determining the status of the component C including predicting the remaining usable lifespan of the component.

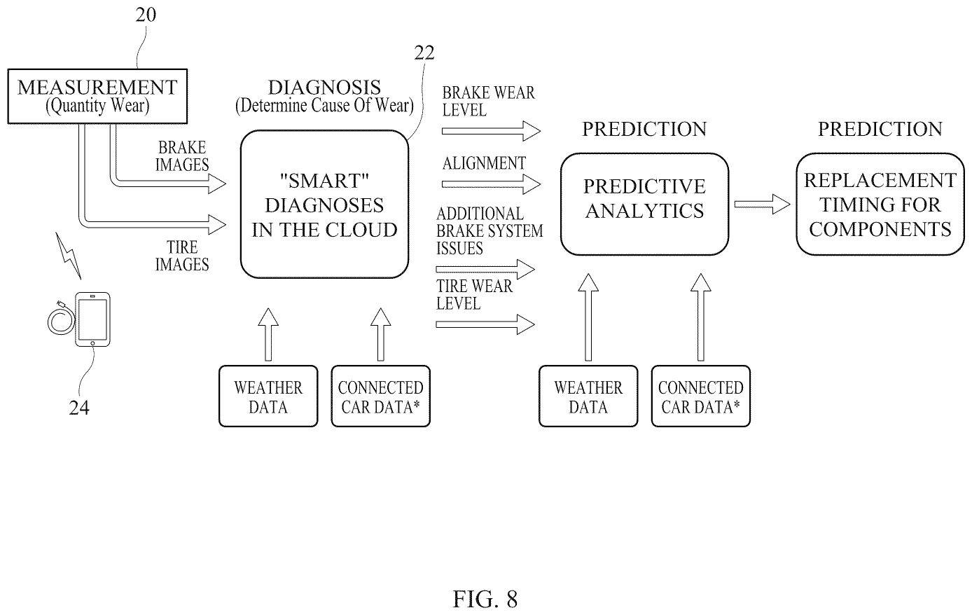

FIG. 8 illustrates another embodiment in which a diagnosis of the cause of wear can be performed. In this embodiment, an image of the component can be acquired, using for example the device 20. For example, an image of the brake pad BP or the tire T can be acquired using the sensor device 12A (sensor device 12). As can be understood, the sensor 12A of the device 20 can capture the wear profile of the component (e.g., the tire T or the brake pad BP or other component such as a filter) using a camera. The wear profile of the component C can then be stored as data related to the wear profile it the storage device 14. In this embodiment, the wear profile of the component C can be stored in the storage device 14B of the remote server 22. Here, the system is configured to make a “smart” diagnosis in the cloud (remote server 22). That is, the system is configured to determine the cause of the wear. The data or information for the vehicle V (connected car data) can also be transmitted to the system. Accordingly, the wireless communicator 16B (including the receiver) receives vehicle information (connected car data) from the vehicle V, the vehicle V information related to the wear profile of the component C. In this embodiment, the vehicle V has acquired the vehicle V data through the environmental sensor 44 and the vehicle sensor 52, as described herein. This information can be transmitted to the remote server using the wireless communicators 58 and 16B and stored in the storage device 14B. In other words, the storage device 14B can store data related to the wear profile of the component C. Furthermore, as discussed herein, the storage device 14 can be the storage device 14A, 14B or 14C of the device 20, the remote server 22 and/or the peripheral device 24.

Moreover, the weather data, i.e., precipitation, temperature, air salt content and any other desired variable is tracked and acquired in any suitable manner, such as the environmental sensor 48, as discussed herein. The weather data can be stored in real time in the computer memory 46 of the vehicle V, or the vehicle V can transmit the vehicle location for a specific time and the vehicle information to the storage device 14B of the remote server 22. This information can enable the system 10 to determine the weather data based on stored weather data for that location and time. In other words, the system 10 can download weather data for a specific date and time from a third party website or server. The weather data and the connected vehicle data can be uploaded into the storage device 14 of the system 10 and associate this information with the image captured by the sensor 12. The weather data and any information related to the vehicle V that occurs outside of the vehicle V can be considered environmental information.

Component wear can be determined by the controller 18B. For example, when the image is a wear profile of a brake pad, the controller 18B can determine the brake wear level and any associated brake system issues based on the image and metadata associated with the image. When the image is a wear profile of a tire T, the controller 18B can determine the tire wear level and any associated tire system issues, such as alignment issues or camber issues based on the image and metadata associated with the image.

Then, the controller 18B can perform predictive analytics. In this embodiment, predicted weather for the vehicle location and predictive connected car data can be uploaded to the storage device 14. For example, given the past vehicle location, the driving environment can be predicted. This information can be provided by historical data from the connected vehicle V, historical data from third party servers or weather predictions for the area from third party websites or servers. Moreover, based on the past driving data of the vehicle V, a predictive driving analysis can be calculated or determined by the controller 18B. Given this information, the controller 18B can provide a prediction of replacement timing for the component. In other words, based on the wear profile from the sensor 12A, the metadata associated with the wear profile and the predicted weather and driving profile, the controller 18B can provide an accurate prediction of the timing of component replacement, and as discussed herein the controller 18 is configured to determine the status of the component based on the environmental information.

As discussed herein, the determination made by the controller 18 and the storage of information can occur in the device 20, at the remote server 22 and/or in the peripheral device 24. These three structural devices can communicate with each other for maximum controller 18 efficiency and utilization of storage space in the storage device 14. Furthermore, any two of the devices can be considered the system for determining the replacement of a component of a vehicle V. For example, in one embodiment, the peripheral device can include a camera and thus capture an image and determine the replacement of a component of a vehicle V by itself or in conjunction with the remote server 22 and/or the device 20.

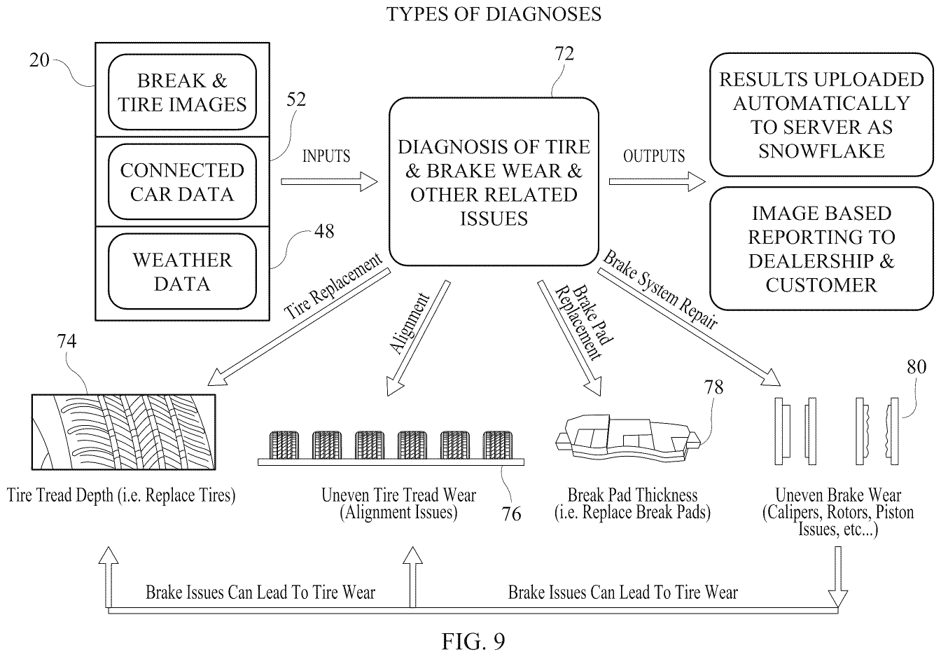

FIG. 9 illustrates a method of diagnosis of a component of a vehicle V. Similarly to the methods described herein, in this embodiment, an image of the component C can be acquired by the sensor 12. In this embodiment, the sensor 12A in the device 20 can capture an image of the component C. For example, an image of the brake pad PD or the tire T can be acquired. As described herein, the sensor 12A captures a wear profile of the component (e.g., the tire T or the brake pad BP or other component such as a filter). Here, the system 10 is configured to make a “smart” diagnosis. That is, the system 10 is configured to determine the cause of the wear. The data or information for the vehicle V can also be transmitted to the system. Accordingly, vehicle sensor 52 determines the vehicle information (connected car data), as discussed herein. This vehicle information can be transmitted to the storage device 14 through the wireless communicator 58 and the wireless communicator 16, such that the wireless communicator receives with the receiver vehicle information from the vehicle V, the vehicle V information related to the wear profile of the component. In this embodiment, the vehicle V has acquired the vehicle information through the wireless communicator 58, as described herein. This information can be stored in the storage device 14. In other words, the storage device 14 can store data related to the wear profile of the component. Furthermore, as discussed herein, the storage device 14 can be the storage device 14 of the device, the remote server and/or the peripheral device.

Moreover, the weather data, i.e., precipitation, temperature, air salt content and any other desired variable is tracked. The weather data can be acquired using the environmental sensor 48 and stored in real time in the computer memory 46 of the vehicle V, or the vehicle V can transmit the vehicle location for specific time and data. This information can enable the system to determine the weather data based on stored weather data for that location and time. In other words, the system 10 can download weather data for a specific date and time from a third party website or server. The weather data and the vehicle information can be uploaded into the system 10 and associated with the image captured by the sensor 12. This information can be stored in the storage device 14 and associated with the wear profile of the component.

Given this information, the controller 18 can provide a diagnosis for the component C at 72. This diagnosis can indicate that the tire depth is such that replacement of the tire is necessary 74 or there is uneven wire wear, such that an alignment of the tire should be performed 76, the inflation of the tire is improper, or the camber of the tire is improper. The diagnosis can also include that the brake pad thickness is such that the brake pad should be replaced 78, or that the brake pad is subject to uneven wear, such that the calipers 62, the rotors 68 and/or the piston 64 should be reviewed and evaluated for replacement or repair 80.

In this embodiment, not only can the controller 18 determine the remaining usable lifespan of the component C, but the controller 18 can further provide corrective action to increase the remaining usable lifespan of the component C.

This information can be automatically uploaded to the remote server 22 as snowflake for storing in the storage device 14B and later use by the system 10 in improving accuracy and/or can be provided to the display device 30 (or the electronic display 32) to enable the dealership and/or customer to review any potential corrections to be made. As can be understood, Snowflake is a cloud-based data warehousing platform known for its scalability, flexibility, and ease of use. It is designed to handle large volumes of data efficiently and cost-effectively by leveraging the benefits of cloud computing platforms. However, the information can be uploaded in any suitable manner.

Furthermore, the system can provide updated information that the brake issues can lead to tire wear and the tire issues can lead to brake wear. In other words, the system 10 is further capable of providing additional diagnosis for cross component diagnosis.

As discussed herein, the determination made by the controller 18 and the storage of information can occur in the device 20, at the remote server 22 and/or in the peripheral device 24. These three structural components can communicate with each other for maximum controller 18 efficiency and utilization of storage space. Furthermore, any two of the devices can be considered the system for determining the wear of a component of a vehicle V. For example, in one embodiment, the peripheral device 24 can include a camera and thus capture an image and determine the replacement of a component of a vehicle V by itself or in conjunction with the remote server and/or the device.

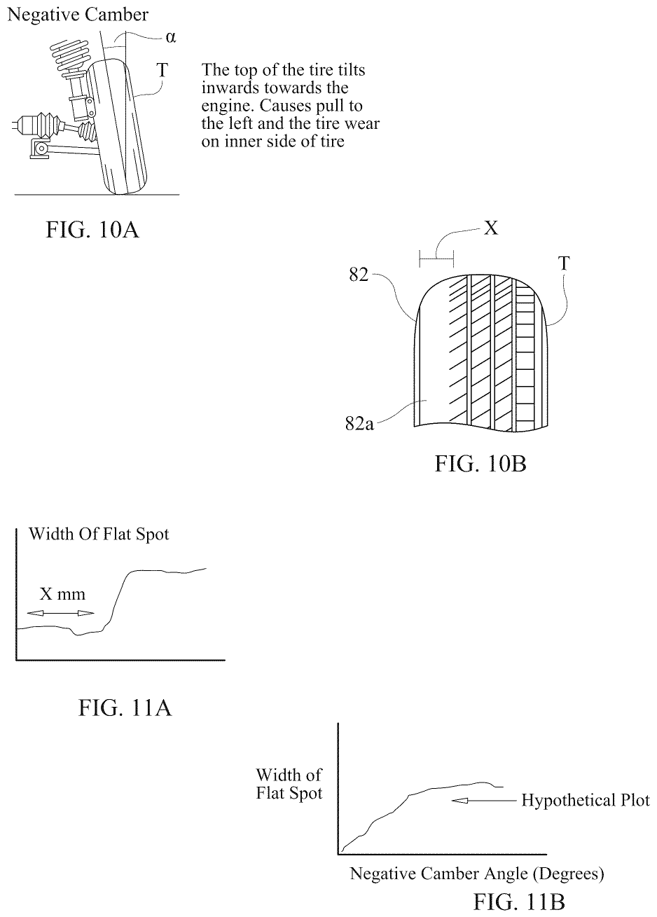

FIGS. 10A and 10B illustrate a diagnosis method for negative camber. As shown in FIG. 10B, the system 10 can determine that the tire has significant wear, forming a flat or worn spot 82a on the inner side 82 of the tire T using the methods described herein. Based on this wear profile, the system 10 can determine that the tire T tilts towards the engine 36 of the vehicle V, which causes the tire T to pull to the inside (the left in FIG. 10B), causing inconsistent wear (flat or worn spot 82a). Such inconsistent wear (flat or worn spot 82a) is diagnosed by the system 10 as negative camber, as shown in FIG. 10A.

As illustrated in FIGS. 11A and 11B, the negative camber angle α can also be determined. That is the system 10 can determine the width X of the flat or worn spot 82a on the inner side 82 of the tire T. The width (i.e., X mm) provides the angle α of chamber. See for example, the hypothetical plot in FIG. 11B. FIG. 11B illustrates that the width X of the flat spot 82a can have a relationship to the negative camber angle α, such that the higher the angle α the greater the width of the width X of the flat spot 82a. Thus, not only can the system 10 provide a diagnosis of the reason for the inconsistent wear (flat or worn spot 82a), but the system 10 can also provide an accurate assessment of corrective angle to be performed to reduce or eliminate the cause of the inconsistent wear.

As can be understood, this diagnosis can occur using the convoluted neural network and a comparison of the image of the wear profile to the stored wear profiles and the “new” profile of the tire T, as discussed herein.

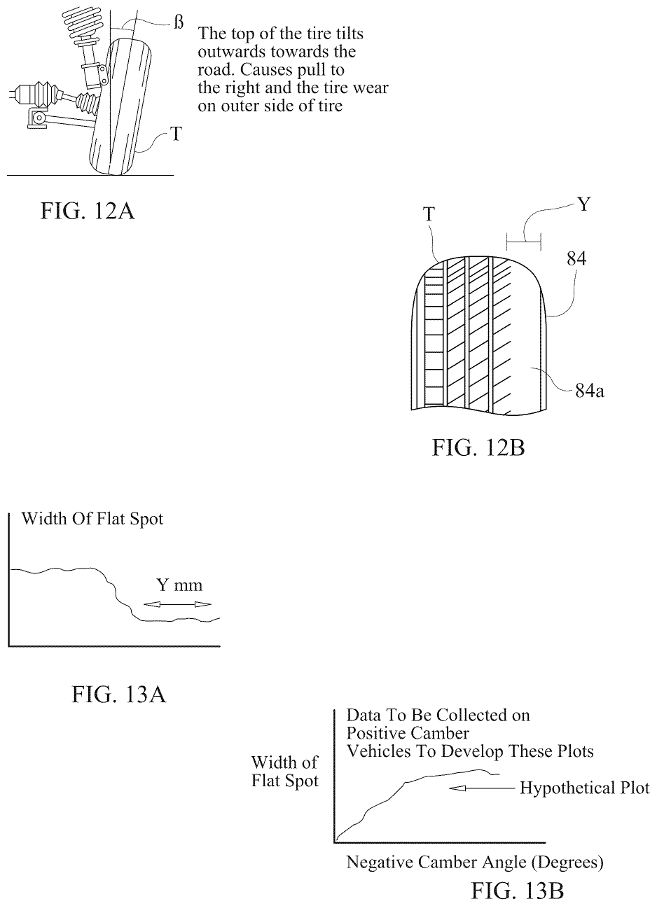

FIGS. 12A and 12B illustrate a diagnosis method for positive camber. As shown in FIG. 12B, the system 10 can determine that the tire T has significant wear, forming a flat or worn spot 84a on the outer side 84 of the tire T. Based on this wear profile, the system 10 can determine that the tire T tilts outward toward the road, which causes the tire T to pull to the outside (the right in FIG. 12B), causing inconsistent wear (flat or worn spot 84a). Such inconsistent wear (flat or worn spot 84a) is diagnosed by the system 10 as positive camber, as shown in FIG. 12A.

As illustrated in FIGS. 13A and 13B, the positive camber angle β can also be determined. That is the system 10 can determine the width Y of the flat or worn spot 84a on the outer side 84 of the tire T. The width (i.e., Y mm) provides the angle β of camber. See for example, the hypothetical plot in FIG. 13B. FIG. 13B illustrates that the width Y of the flat spot 84a can have a relationship to the positive camber angle β, such that the higher the angle β the greater the width of the width Y of the flat spot 84a. Thus, not only can the system 10 provide a diagnosis of the reason for the inconsistent wear (flat or worn spot 84a), but the system 10 can also provide an accurate assessment of corrective angle to be performed to reduce or eliminate the cause of the inconsistent wear.

As can be understood, this diagnosis can occur using the convoluted neural network and a comparison of the image of the wear profile to the stored wear profiles and the “new” profile of the tire T, as discussed herein.

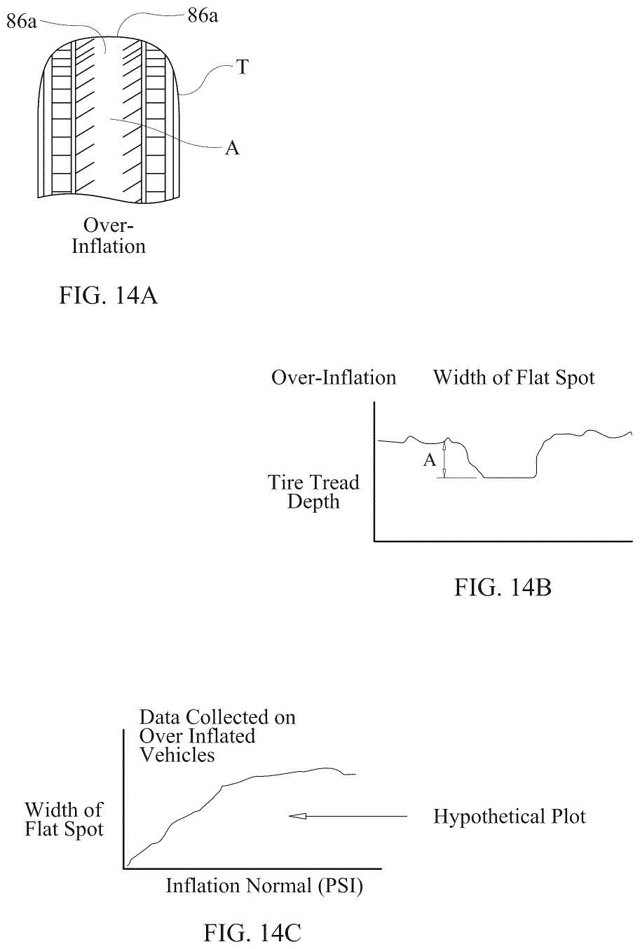

FIGS. 14A-14C illustrate a diagnosis method for over inflation. As shown in FIG. 14A, the system 10 can determine that the tire has significant wear, forming a flat or worn spot 86a on the central portion 86 of the tire T. Based on this wear profile, the system 10 can determine that the tire is T over inflated causing inconsistent wear (flat or worn spot 86a). Such inconsistent wear (flat or worn spot 86a) is diagnosed by the system 10 as over inflation, as shown in FIG. 14A.

As illustrated in FIGS. 14B and 14C, the amount of over inflation can also be determined. That is the system 10 can determine the depth A of the flat or worn spot 86a on the central portion 86 of the tire T, as shown in FIG. 14B. The depth A provides the amount of over inflation. See for example, the hypothetical plot in FIG. 14C. FIG. 14C illustrates that the depth A of the flat spot 86a can have a relationship to the tire inflation, such that the higher the inflation of the tire T, the greater the width of the depth A of the flat spot 86a. Thus, not only can the system 10 provide a diagnosis of the reason for the inconsistent wear (flat or worn spot 86a), but the system 10 can also provide an accurate assessment of corrective inflation to be performed to reduce or eliminate the cause of the inconsistent wear.

As can be understood, this diagnosis can occur using the convoluted neural network and a comparison of the image of the wear profile to the stored wear profiles and the “new” profile of the tire T, as discussed herein.

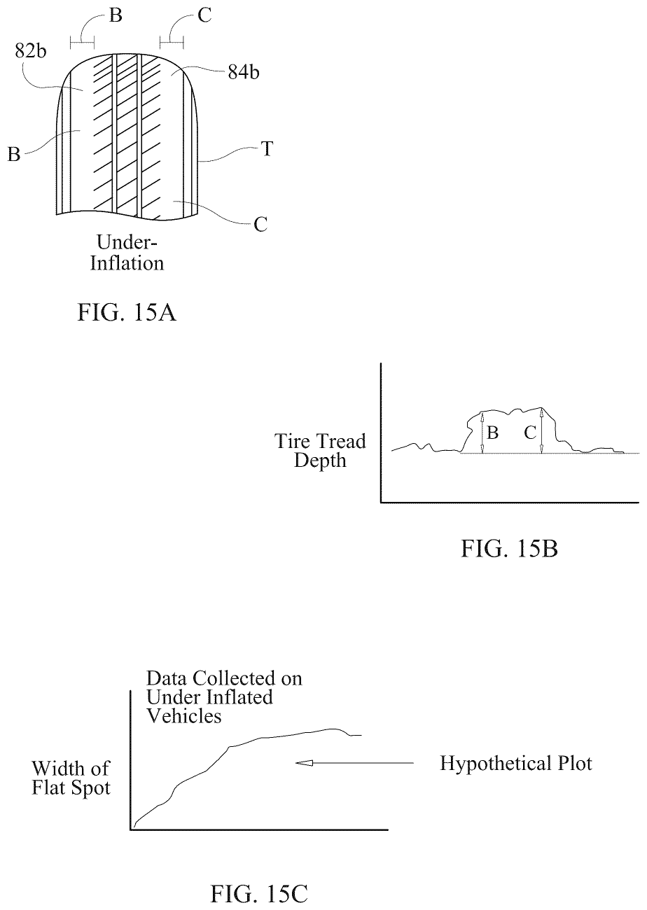

FIGS. 15A-15C illustrate a diagnosis method for under inflation. As shown in FIG. 15A, the system 10 can determine that the tire T has significant wear forming a flat or worn spot 82b on the inner portion 82 and a flat or worn spot 84b on outer portion 84 of the tire T. Based on this wear profile, the system 10 can determine that the tire T is under inflated causing inconsistent wear (flat or worn spot 82b and flat or worn spot 84b). Such inconsistent wear is diagnosed by the system 10 as under inflation, as shown in FIG. 15A.

As illustrated in FIGS. 15B and 15C, the amount of under inflation can also be determined. That is the system 10 can determine the depth C of the flat or worn spot 82b on the inner portion 82 of the tire T and the depth 84b on the outer portion 84 of the tire T, as shown in FIG. 15B. See for example, the hypothetical plot in FIG. 15C. FIG. 15C illustrates that the depth B of the flat spot 82 b and the depth C of the flat spot 84b can have a relationship to the tire inflation, such that the lower the inflation of the tire T, the greater the width of the depth B of the flat spot 82a and the depth C of the flat spot 84b. The depth B and the depth C provide the amount of over inflation. Thus, not only can the system 10 provide a diagnosis of the reason for the inconsistent wear (flat or worn spot 82b and flat or worn spot 84b), but the system 10 can also provide an accurate assessment of corrective deflation to be performed to reduce or eliminate the cause of the inconsistent wear.

As can be understood, this diagnosis can occur using the convoluted neural network and a comparison of the image of the wear profile to the stored wear profiles and the “new” profile of the tire T, as discussed herein.

As can be understood, the storage device 14 can be include a non-transitory machine-readable medium storing instructions which, when executed by one or more processor (e.g., the controller 18s), causes the one or more processor to execute the methods described herein.

By providing a device and method as disclosed herein, accurate predictions of wear and use of a component can be achieved. That is, the system as disclosed herein can predict the useable lifespan remaining on a component and provide an accurate evaluation of when the component will be required to be replaced. Moreover, the system is capable of diagnosing potential errors in the operation and configuration of the component or related components and provide real time recommendations for improving use and operation of the components and the related components.

The calipers 62, pistons 64 and rotors 68 are conventional components that are well known in the art. Since calipers, pistons and rotors are well known in the art, these structures will not be discussed or illustrated in detail herein. Rather, it will be apparent to those skilled in the art from this disclosure that the components can be any type of structure and/or programming that can be used to carry out the present disclosure.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle V equipped with the system for determining wear of a component of a vehicle. Accordingly, these terms, as utilized to describe the present disclosure should be interpreted relative to a vehicle V equipped with the system for determining wear of a component of a vehicle.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present disclosure, it will be apparent to those skilled in the art from this disclosure that various changes and modifications can be made herein without departing from the scope of the disclosure as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further disclosures by the applicant, including the structural and/or functional concepts embodied by such feature(s). Thus, the foregoing descriptions of the embodiments according to the present disclosure are provided for illustration only, and not for the purpose of limiting the disclosure as defined by the appended claims and their equivalents.

What is claimed is:

1. A system for determining wear of a component of a vehicle, the system comprising:
a sensor configured to determine a wear profile of the component;
a storage device configured to store data related to the wear profile of the component;
a receiver configured to receive vehicle information from the vehicle, the vehicle information related to the wear profile of the component; and
a controller configured to determine a status of the component based on a comparison of the wear profile of the component and the data related to the wear profile of the component and based on the vehicle information related to the to the wear profile of the component.

2. The system according to claim 1, wherein
the sensor is configured to determine the wear profile of a brake pad, a tire or a filter.

3. The system according to claim 1, wherein
the storage service is configured to store data related to a wear profile of a brake pad, a tire or a filter.

4. The system according to claim 1, wherein
the controller is configured to determine the status of the component includes predicting the remaining usable lifespan of the component.

5. The system according to claim 4, wherein
the controller is configured to provide corrective action to increase the remaining usable lifespan of the component.

6. The system according to claim 4, wherein
the controller is configured to operate a component of the vehicle to increase the remaining usable lifespan of the component.

7. The system according to claim 1, wherein
the controller is configured to transmit the wear profile of the component and the vehicle information to a remote server.

8. The system according to claim 1, wherein
the controller is configured to receive environmental information related to the wear profile of the component from a remote server.

9. The system according to claim 8, wherein
the controller is configured to determine the status of the component based on the environmental information.

10. A method for determining wear of a component of a vehicle, the method comprising:
determining, using a sensor, a wear profile of the component;
retrieving data related to the wear profile of the component from a storage device;
receiving, via a receiver, vehicle information from the vehicle, the vehicle information related to the wear profile of the component; and
determining, via a controller, a status of the component based on a comparison of the wear profile of the component and the data related to the wear profile of the component and based on the vehicle information related to the to the wear profile of the component.

11. The method according to claim 10, wherein
the determining the wear profile includes determining the wear profile of a brake pad, a tire or a filter.

12. The method according to claim 10, wherein
the storage service stores data related to a wear profile of a brake pad, a tire or a filter.

13. The method according to claim 10, wherein
the determining the status of the component includes predicting the remaining usable lifespan of the component.

14. The method according to claim 13, further comprising
providing, via the controller, corrective action to increase the remaining usable lifespan of the component.

15. The method according to claim 13, further comprising
operating, using the controller, a component of the vehicle to increase the remaining usable lifespan of the component.

16. The method according to claim 10, further comprising
transmitting, via the controller, t the wear profile of the component and the vehicle information to a remote server.

17. The method according to claim 10, further comprising
receiving environmental information related to the wear profile of the component from a remote server.

18. The method according to claim 17, wherein
the determining the status of the component includes determining the status of the component based on the environmental information.

19. A non-transitory machine-readable medium storing instructions which, when executed by one or more processor, causes the one or more processor to execute the method of claim 10.

20. A method of training a system for determining wear of a component of a vehicle, the method comprising:
capturing a plurality of images related to a wear profile of the component;
transmitting the plurality of images to a remote server;
transmitting information related to the vehicle to the remote server;
concatenating the images of the wear profile of the component to the information related to the vehicle to provide concatenated information; and
inputting the concatenated information into a machine learning model to provide an output predicting the remaining usable lifespan of the component.
